(19) United States
(12) Patent Application Publication
(10) Pub. No.: US 2019/0107945 A1
(43) Pub. Date: Apr. 11, 2019

(54) CONTROLLER FOR CONTROLLING ONE OR MORE MEMORY DEVICES AND OPERATION METHOD THEREOF

(71) Applicant: SK hynix Inc., Gyeonggi-do (KR)

(72) Inventor: Dong-Yeob CHUN, Seoul (KR)

(21) Appl. No.: 15/971,618

(22) Filed: May 4, 2018

(30) Foreign Application Priority Data
Oct. 11, 2017 (KR) 10-2017-0129778

(51) Int. Cl. G06F 3/06

(52) U.S. Cl. CPC G06F 3/061; G06F 3/0679; G06F 3/0638

(57) ABSTRACT

In accordance with an embodiment of the present invention, a controller may include a buffer for storing a plurality of commands in accordance with an input order; a setting unit for setting order information of a read status check operation to be performed on respective storage devices corresponding to the plurality of commands, wherein the storage devices are included in a memory device; a performing unit for controlling the memory device to sequentially perform the read status check operation based on the order information; and a processor for controlling the memory device to perform a command operation in response to the plurality of commands based on a result of the read status check operation.

### CROSS-REFERENCE TO RELATED APPLICATIONS

The present application claims priority under 35 U.S.C. § 119(a) to Korean Patent Application No. 10-2017-0129778 filed on Oct. 11, 2017, the disclosure of which is incorporated herein by reference in its entirety.

### BACKGROUND

### 1. Field

Various exemplary embodiments of the present invention relate to a controller and, more particularly, to a controller that maximizes the performance of a memory system, and an operation method thereof.

### 2. Description of the Related Art

The computer environment paradigm has changed to ubiquitous computing systems that can be used anytime and anywhere. That is, use of portable electronic devices such as mobile phones, digital cameras, and notebook computers has rapidly increased. These portable electronic devices generally use a memory system having one or more memory devices for storing data. A memory system may be used as a main memory device or an auxiliary memory device of a portable electronic device.

Memory systems provide excellent stability, durability, high information access speed, and low power consumption because they have no moving parts. Examples of memory systems having such advantages include universal serial bus (USB) memory devices, memory cards having various interfaces, and solid state drives (SSD).

### SUMMARY

Various embodiments of the present invention are directed to a controller for improving the performance of a read operation, and an operation method thereof.

In accordance with an embodiment of the present invention, a controller may include a buffer for storing a plurality of commands in accordance with an input order; a setting unit for setting order information of a read status check operation to be performed on respective storage devices corresponding to the plurality of commands, wherein the storage devices are included in a memory device; a performing unit for controlling the memory device to sequentially perform the read status check operation based on the order information; and a processor for controlling the memory device to perform a command operation in response to the plurality of commands based on a result of the read status check operation.

The buffer may have a ring buffer structure.

When the plurality of commands may be commands for sequential data, the order information to be the same as the order of input commands for the sequential data.

The performing unit may control the storage devices to repeatedly perform the status check for each storage device until a command operation performed in each of the storage devices is completed.

The performing unit may control the memory device to perform a read status check operation corresponding to a subsequent command, after the command operation for a preceding command is completed according to the order information.

When the plurality of commands may be commands for random data, the order information to be the same as the order of input commands for the random data.

The performing unit may control the memory device to alternately perform the read status check operation on the storage devices until the command operation on the storage devices is completed.

The setting unit may change, when one or more storage devices is determined as busy according to a result of performing the read status check operation on each of the storage devices, the order information based on the command information.

The command information may include predetermined duration information of a busy status for a storage device corresponding to a corresponding command.

The setting unit may compare the duration information corresponding to the preceding command with the duration information corresponding to the subsequent command based on the command information and changes the order information so as to preferentially control the memory device to perform the read status check operation to the subsequent command having the shorter time.

The performing unit may control the memory device to sequentially perform the read status check operation based on the changed order information.

The setting unit may change, when a subsequent command is a read command and is issued while a write operation is being performed in response to a preceding write command, the order information to perform the read status check operation on the storage device corresponding to the read command first.

The performing unit may control the memory device to interrupt the write operation and perform the read status check operation corresponding to the read command.

The processor may control the memory device to perform a read operation corresponding to the read command based on the status of a corresponding storage device.

After the read operation may be completed, the processor controls the memory device to resume the interrupted write operation.

The storage device includes a way of a memory device.

In accordance with an embodiment of the present invention, an operating method of a controller may include a first step of storing a plurality of commands in a buffer according to an input order of the commands; second step of storing order information of a read status check operation to be performed for each of a plurality of storage devices of a memory device corresponding to each of the plurality of commands; a third step of controlling the memory device to sequentially perform the read status check operation to the storage devices based on the order information; and a fourth step of controlling the memory device to perform command operations in response to the plurality of commands based on a result of the read status check operation.

The buffer may have a ring buffer structure.

The second step may store, when the plurality of commands are commands for sequential data, the order information in the same order as the order of input commands for the sequential data, and wherein the third step controls the storage devices to repeatedly perform the read status check operation for each storage device until a command operation performed in each of the storage devices is completed.

The third step may control the memory device to perform the status check operation on a subsequent command after the command operation for a preceding command is completed according to the order information.

The second step may set, when the plurality of commands are commands for random data, the order format on to be the same as the order of input commands for the random data, and wherein the third step controls the memory device to alternately perform the read status check operation on the storage devices until the command operation on the storage devices is completed.

A fifth step of changing, when one or more storage devices determined as busy according to a result of the performing of the read status check operation on each of the storage devices, the order information based on the command information, wherein the command information includes predetermined duration information of a busy status for a storage device corresponding to a corresponding command.

The fifth step may compare the duration information corresponding to the preceding command with the duration information corresponding to the subsequent command based on the command information and changes the order information so as to preferentially control the memory device to perform the read status check operation to the subsequent command having the shorter time, and further comprising, a sixth step of controlling the memory device to sequentially perform the read status check operation based on the changed order information.

The second step may change, when a subsequent command is a read command and is issued while a write operation is being performed in response to a preceding write command, the order information to perform the read status check operation on the storage device corresponding to the read command first, and wherein the third step controls the memory device to interrupt the write operation and perform the read status check operation corresponding to the read command, and wherein the fourth step controls the memory device to perform a read operation corresponding to the read command based on the status of a corresponding storage device.

After the read operation may be completed, the memory device to resume the interrupted write operation again.

The storage device may include a way of a memory device.

In accordance with an embodiment of the present invention, a memory system may include a memory device including a plurality of storage devices; and a controller suitable for: performing, in response to an ordered sequence of commands, an ordered sequence of status check operations to the storage devices respectively corresponding to the ordered sequence of commands; and performing a plurality of command operations respectively corresponding to the commands according to results of the status check operations, wherein the performing of the ordered sequence of status check operations includes repeating the status check operation corresponding to a next command until completion of a current command operation.

According to the embodiment of the present invention, performance of the read operation of the controller can be improved through an efficient status check.

### BRIEF DESCRIPTION OF THE DRAWINGS

FIG. 1 is a block diagram illustrating a data processing system including a memory system, in accordance with an embodiment of the present invention.

FIG. 2 is a schematic diagram illustrating an exemplary configuration of a memory device employed in the memory system shown in FIG. 1.

FIG. 3 is a circuit diagram illustrating an exemplary configuration of a memory cell array of a memory block in the memory device shown in FIG. 2.

FIG. 4 is a schematic diagram illustrating an exemplary three-dimensional structure of the memory device shown in FIG. 2.

FIG. 5 is a schematic diagram illustrating a structure of a controller and a memory device, in accordance with an embodiment of the present invention.

FIG. 6A is a timing diagram showing the operation of the controller, in accordance with the embodiment of the present invention.

FIG. 6B is a timing diagram showing the operation of the controller, in accordance with another embodiment of the present invention.

FIG. 7 is a timing diagram showing the operation of the controller, in accordance with another embodiment of the present invention.

FIG. 8 is a flowchart illustrating an operation of a controller, in accordance with another embodiment of the present invention.

FIGS. 9 to 17 are diagrams schematically illustrating application examples of a data processing system, in accordance with various embodiments of the present invention.

### DETAILED DESCRIPTION

Various embodiments of the present invention are described below in more detail with reference to the accompanying drawings. We note, however, that the present invention may be embodied in different other embodiments, forms and variations thereof and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or electrically connected or coupled to the latter via an intervening element therebetween.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention.

As used herein, singular forms are intended to include the plural forms as well, unless the context clearly indicates otherwise.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art, and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

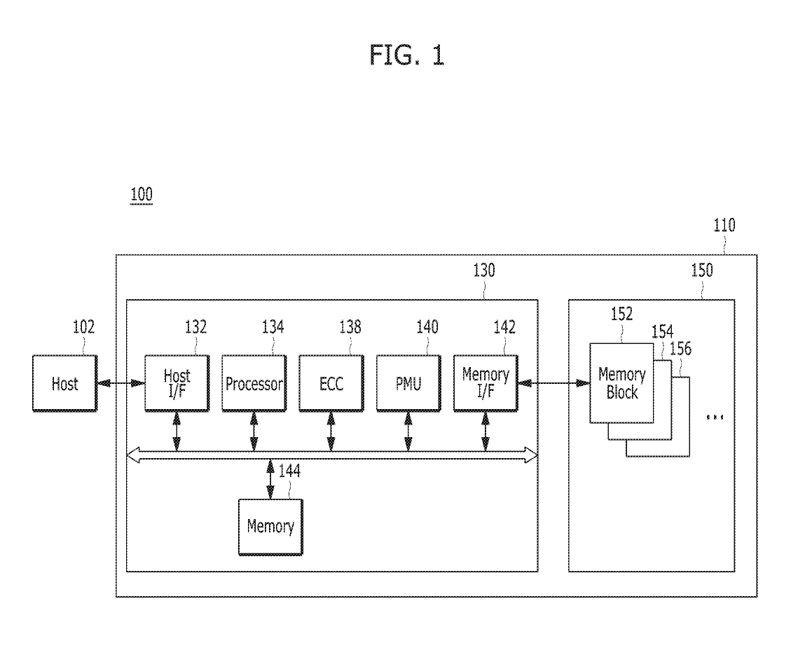

FIG. 1 is a block diagram illustrating a data processing system 100 in accordance with an embodiment of the present invention.

Referring to FIG. 1, the data processing system 100 may include a host 102 operatively coupled to a memory system 110.

The host 102 may include, for example, a portable electronic device such as a mobile phone, an MP3 player and a laptop computer or an electronic device such as a desktop computer, a game player, a TV, a projector and the like.

The memory system 110 may operate in response to a request from the host 102, and in particular, store data to be accessed by the host 102. The memory system 110 may be used as a main memory system or an auxiliary memory system of the host 102. The memory system 110 may be implemented with any one of various types of storage devices, which may be electrically coupled with the host 102, according to a protocol of a host interface. Examples of suitable storage devices include a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and the like.

The storage devices for the memory system 110 may be implemented with a volatile memory device such as a dynamic random access memory (DRAM) and a static RAM (SRAM) and nonvolatile memory device such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM) and a flash memory.

The memory system 110 may include a memory device 150 which stores data to be accessed by the host 102, and a controller 130 which may control storage of data in the memory device 150.

The controller 130 and the memory device 150 may be integrated into a single semiconductor device, which may be included in the various types of memory systems as exemplified above.

The memory system 110 may be configured as part of a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3D television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various component elements configuring a computing system.

The memory device 150 may be a nonvolatile memory device and may retain data stored therein even though power is not supplied. The memory device 150 may store data provided from the host 102 through a write operation, and provide data stored therein to the host 102 through a read operation. The memory device 150 may include a plurality of memory blocks 152 to 156, each of the memory blocks 152 to 156 may include a plurality of pages. Each of the pages may include a plurality of memory cells to which a plurality of word lines (WL) are electrically coupled.

The controller 130 may control overall operations of the memory device 150, such as read, write, program and erase operations. For example, the controller 130 of the memory system 110 may control the memory device 150 in response to a request from the host 102. The controller 130 may provide the data read from the memory device 150, to the host 102, and/or may store the data provided from the host 102 into the memory device 150.

The controller 130 may include a host interface (I/F) unit 132, a processor 134, an error correction code (ECC) unit 138, a power management unit (PMU) 140, a memory device controller 142 such as a NAND flash controller (NFC) 142 and a memory 144 all operatively coupled via an internal bus.

The host interface unit 132 may process commands and data provided from the host 102, and may communicate with the host 102 through at least one of various interface protocols such as universal serial bus (USB), multimedia card (MMC), peripheral component interconnect-express (PCI-E), small computer system interface (SCSI), serial-attached SCSI (SAS), serial advanced technology attachment (SATA), parallel advanced technology attachment (PATA), small computer system interface (SCSI), enhanced small disk interface (ESDI) and integrated drive electronics (IDE).

The ECC unit 138 may detect and correct errors in the data read from the memory device 150 during the read operation. The ECC unit 138 may not correct error bits when the number of the error bits is greater than or equal to a threshold number of correctable error bits, and may output an error correction fail signal indicating failure in correcting the error bits.

The ECC unit 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC unit 138 may include all units, modules, systems or devices for the error correction operation.

The PMU 140 may provide and manage power of the controller 130.

The NFC 142 may serve as a memory/storage interface between the controller 130 and the memory device 150 to allow the controller 130 to control the memory device 150 in response to a request from the host 102. The NFC 142 may generate a control signal for the memory device 150 and process data to be provided to the memory device 150 under the control of the processor 134 when the memory device 150 is a flash memory and, in particular, when the memory device 150 is a NAND flash memory.

The memory 144 may serve as a working memory of the memory system 110 and the controller 130, and store data for driving the memory system 110 and the controller 130. The controller 130 may control the memory device 150 in response to a request from the host 102. The controller 130 may provide data read from the memory device 150 to the host 102, may store data provided from the host 102 into the memory device 150. The memory 144 may store data required for the controller 130 and the memory device 150 to perform these operations.

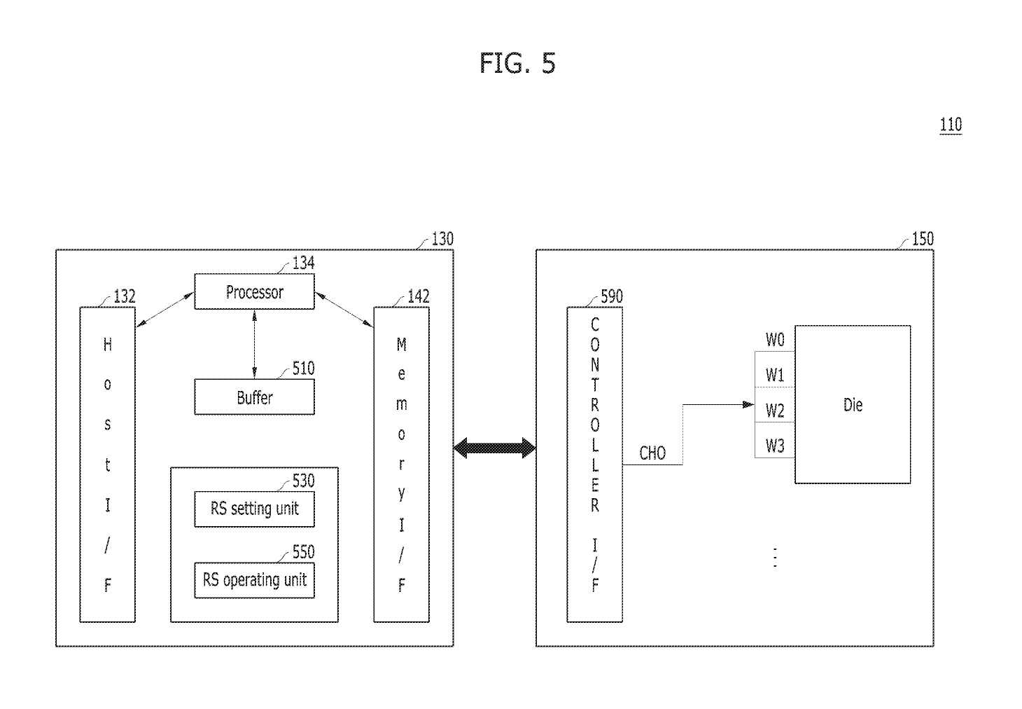

The memory 144 may include a mailbox for storing data for communication between a plurality of processors (See FIG. 5).

The memory 144 may be implemented with a volatile memory. The memory 144 may be implemented with a static random access memory (SRAM) or a dynamic random access memory (DRAM). The memory 144 may be disposed within or out of the controller 130. FIG. 1 exemplifies the memory 144 disposed within the controller 130. In an embodiment, the memory 144 may be embodied by an external volatile memory having a memory interface transferring data between the memory 144 and the controller 130.

The processor 134 may control the overall operations of the memory system 110. The processor 134 may drive firmware, which is referred to as a flash translation layer (FTL), to control the general operations of the memory system 110.

A FTL may perform an operation as an interface between the host 102 and the memory device 150. The host 102 may request to the memory device 150 write and read operations through the FTL.

The FTL may manage operations of address mapping, garbage collection, wear-leveling and so forth. Particularly, the FTL may store map data. Therefore, the controller 130 may map a logical address, which is provided from the host 102, to a physical address of the memory device 150 through the map data. The memory device 150 may perform an operation like a general device because of the address mapping operation. Also, through the address mapping operation based on the map data, when the controller 130 updates data of a particular page, the controller 130 may program new data into another empty page and may invalidate old data of the particular page due to a characteristic of a flash memory device. Further, the controller 130 may store map data of the new data into the FTL.

Further, the FTL may re-build the map data during the sudden power off recovery (SPOR) operation. The SPOR operation may be performed during a booting operation at least after an abnormal power off. In accordance with an embodiment of the present invention, an operating method of a memory system may re-build a map data during a booting after an abnormal power off.

The processor 134 may be implemented with a microprocessor or a central processing unit (CPU). The memory system 110 may include one or more processors 134.

A management unit (not shown) may be included in the processor 134, and may perform bad block management of the memory device 150. The management unit may find bad memory blocks included in the memory device 150, which are in unsatisfactory condition for further use, and perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. Also, the bad blocks due to the program fail seriously deteriorates the utilization efficiency of the memory device 150 having a 3D stack structure and the reliability of the memory system 100, and thus reliable bad block management is required.

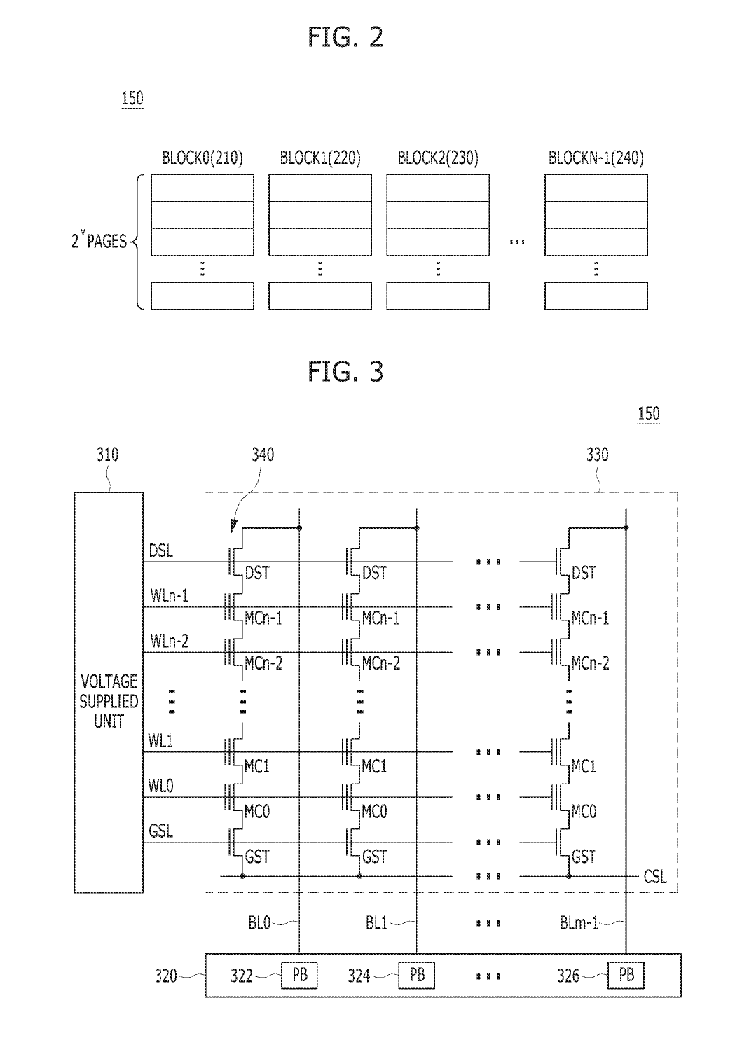

FIG. 2 is a schematic diagram illustrating the memory device 150.

Referring to FIG. 2, the memory device 150 may include the plurality of memory blocks BL0CK 0 to BL0CKN−1, and each of the blocks BL0CK 0 to BL0CKN−1 may include a plurality of pages, for example, 2^{M} pages, the number of which may vary according to circuit design. The memory device 150 may include a plurality of memory blocks, as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data. An MLC memory block including a plurality of pages which are implemented with memory cells that are each capable of storing 3-bit data may be defined as a triple level cell (TLC) memory block.

Each of the plurality of memory blocks 210 to 240 may store the data provided from the host device 102 during a write operation, and may provide stored data to the host 102 during a read operation.

FIG. 3 is a circuit diagram illustrating a memory block 330 in the memory device 150.

Referring to FIG. 3, the memory block 330 which corresponds to any of the plurality of memory blocks 152 to 156.

Referring to FIG. 3, the memory block 152 of the memory device 150 may include a plurality of cell strings 340 which are electrically coupled to bit lines BL0 to BLm−1, respectively. The cell string 340 of each column may include at least one drain select transistor DST and at least one source select transistor SST. A plurality of memory cells or a plurality of memory cell transistors MC0 to MCn−1 may be electrically coupled in series between the select transistors DST and SST. The respective memory cells MC0 to MCn−1 may be configured by single level cells (SLC) each of which may store 1 bit of information, or by multi-level cells (MLC) each of which may store data information of a plurality of bits. The strings 340 may be electrically coupled to the corresponding bit lines BL0 to BLm−1, respectively. For reference, in FIG. 3, ‘DSL’ denotes a drain select line, ‘SSL’ denotes a source select line, and ‘CSL’ denotes a common source line.

While FIG. 3 only shows, as an example, the memory block 152 which is configured by NAND flash memory cells, it is to be noted that the memory block 152 of the memory device 150 according to the embodiment is not limited to NAND flash memory and may be realized by NOR flash memory, hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A voltage supplied unit 310 of the memory device 150 may provide word line voltages, for example, a program voltage, a read voltage and a pass voltage, to be supplied to respective word lines according to an operation mode and voltages to be supplied to bulks, for example, well regions in which the memory cells are formed. The voltage supplied unit 310 may perform a voltage generating operation under the control of a control unit (not shown). The voltage supplied unit 310 may generate a plurality of variable read voltages to generate a plurality of read data, select one of the memory blocks or sectors of a memory cell array under the control of the control unit, select one of the word lines of the selected memory block, and provide the word line voltages to the selected word line and unselected word lines.

A read/write unit 320 of the memory device 150 may be controlled by the control unit, and may serve as a sense amplifier or a write driver according to an operation mode. During a verification/normal read operation, the read/write unit 320 may operate as a sense amplifier for reading data from the memory cell array. During a program operation, the read/write unit 320 may operate as a write driver for driving bit lines according to data to be stored in the memory cell array. During a program operation, the read/write unit 320 may receive from a buffer (not illustrated) data to be stored into the memory cell array, and drive bit lines according to the received data. The read/write unit 320 may include a plurality of page buffers 322 to 326 respectively corresponding to columns (or bit lines) or column pairs (or bit line pairs), and each of the page buffers 322 to 326 may include a plurality of latches (not illustrated).

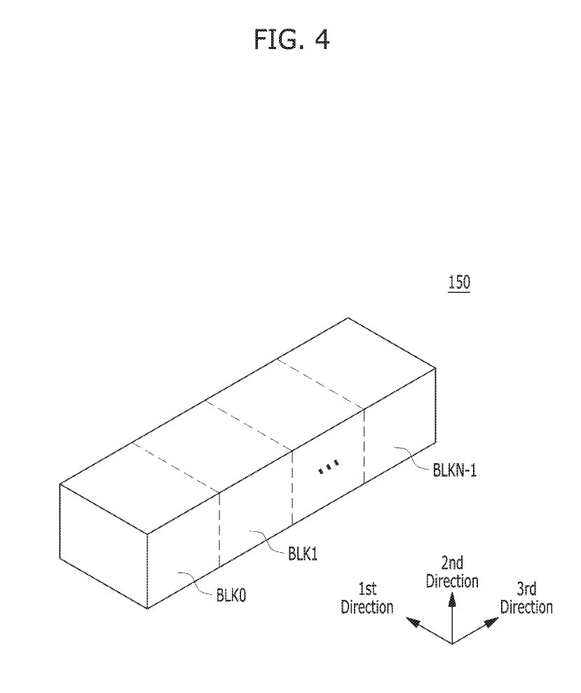

FIG. 4 is a schematic diagram illustrating a 3D structure of the memory device 150.

The memory device 150 may be embodied by a 2D or 3D memory device. Specifically, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN−1 each having a 3D structure (or vertical structure).

Referring to FIG. 1, the host 102 may issue a read command or write command to the controller 130. The controller 130 may control the storage device to sequentially perform operations corresponding to the issued command from the host 102. The storage device may be a page or a way in the memory device 150. Hereinafter, for convenience of description, only a way is described.

Before performing the operation corresponding to the command, the operation for checking the status of a certain way may be preceded in order to perform the operation. To check the status of a certain way, the controller 130 may issue a read status check command to the way. The memory device 150 may inform the controller 130 of the current status of the certain way representing whether the certain way is ready or busy in response to the status check command. Such status check may be performed periodically. Thus, the controller 130 may control the memory device 150 to perform a status check operation to determine whether the way is in a ready or busy status.

The performance of the memory system 110 may be improved by processing the input/output (I/O) operation as the status check operation in a short time. However, when the controller 130 requests a status check on each of a plurality of ways, such as interleaved ways, there is a need to arrange an order of the status check operations. Specially, when the controller 130 controls the memory device for sequential data, the status of each way may be different and thus the read performance of the controller 130 for the sequential data may be reduced. Thus, the present invention proposes an operating method for the controller 130 in the case where the above situation may occur. Hereinafter, with reference to FIGS. 5 to 8, the operation of the controller 130 will be described according to the embodiment of the present invention.

FIG. 5 is a schematic diagram illustrating a structure of a controller and a memory device according to an embodiment of the present invention.

Referring to FIGS. 1 and 5, the controller 130 includes the host interface unit 132, the processor 134, and the memory interface unit 142, and may further include a buffer 510, a Read Status (RS) setting unit 530, and a Read Status (RS) performing unit 550.

The host interface unit 132 processes the command and data provided from and/or to the host 102 for exchanging data between the memory system 110 and the host 102.

In addition, in order for the controller 130 to control the memory device 150 in response to a request from the host 102, the memory interface unit 142 may perform interfacing between the controller 130 and the memory device 150. Specially, the memory interface unit 142 may support data input/output between the controller 130 and the memory device 150 and may be driven through firmware called FTL for exchanging data between the controller 130 and the memory device 150.

Furthermore, the processor 134 may control the overall operation of the memory system 110 and may control program operation or read operations for the memory device 150 in response to a write request or a read request from the host 102. The processor 134 may drive firmware called FTL to control overall operations of the memory system 110. The firmware may manage the operation of the host 102, the controller 130 and the memory device 150 to process the data. Specifically, the firmware may receive a command set from the host and transfer the received command set to the memory device.

The controller 130 may store a plurality of commands in the buffer 510 according to the input order. Further, the structure of the buffer 510 may have a ring buffer structure. The ring buffer is structured in the form of a ring such that the tail and the head of the buffer are connected, and may process data from the data stored in the head.

Due to the characteristics of the ring buffer, when a read operation corresponding to a sequential read command is performed, the read performance in the memory system may be reduced since the data stored in the head is first processed even when the data stored at the tail of the buffer must be processed. For example, when the first to fourth read commands are issued from the host 102, if the buffer 510 is a ring buffer structure, there may be a chance that the first and second read commands are stored in the tail of the buffer and the third and fourth read commands may be stored in the head of the buffer. As a result, the controller 130 may process the first and second read commands after processing the third and fourth read commands. Therefore, there may be a need for the controller 130 to store information on the order of the read commands.

The Read Status (RS) setting unit 530 may store the order information of the status check operation to be performed for each of a plurality of ways. For example, when the order of the read commands is ‘0-1-2-3’, the RS setting unit 510 may store the order information on the status check operation of the corresponding way according to the order of the read commands (i.e., the first to fourth read commands in order).

The Read Status (RS) performing unit 550 may control the ways to perform the status check operation of each of the plurality of ways based on the order information. However, the RS performing unit 550 may not concurrently perform the status check operations on a plurality of ways sharing one channel. That is, after the status check operation for a first way is terminated, the RS performing unit 550 may control the memory device 150 to perform the status check operation to a second way. Further, after the status check operation of the way is completed, the processor 134 may control the memory device 150 to perform an input/output (I/O) operation in response to a command.

Referring to FIG. 1, the memory device 150 may include a controller interface unit 590 for transferring commands and data between the controller 130 and the memory device 150 and a plurality of dies. Each of the dies is connected to the controller interface unit 590 through a channel, and the channel may be configured with a plurality of ways. That is, a plurality of ways may share one channel. For example, the 0th way W0 to the 3rd way may share the 0th channel. Furthermore, a plurality of ways may be connected to one die. Hereinafter, the controller 130 performs a status check operation on a plurality of ways that share one channel.

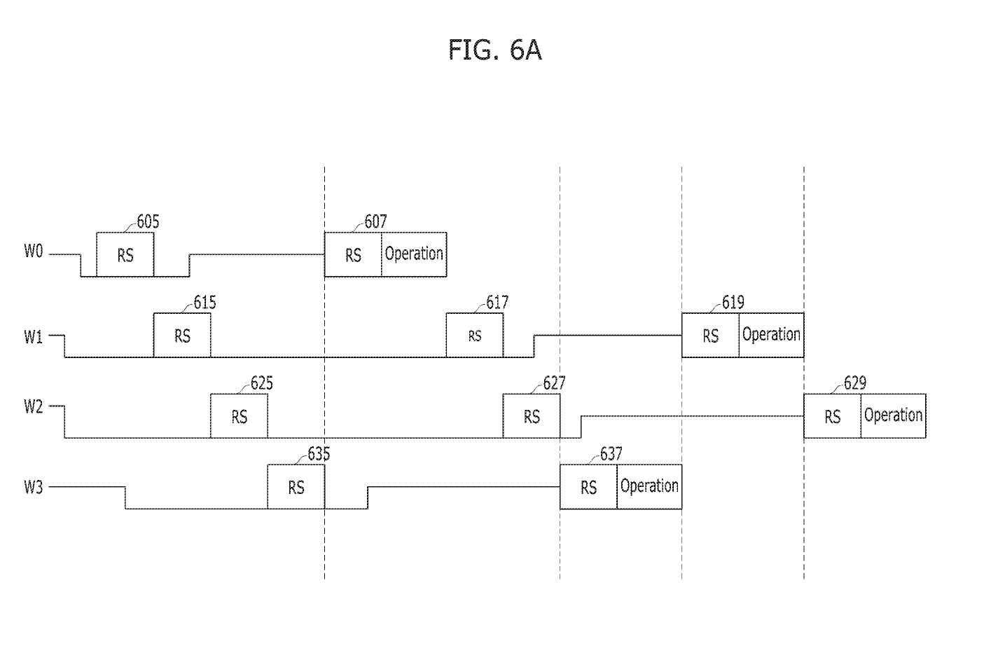

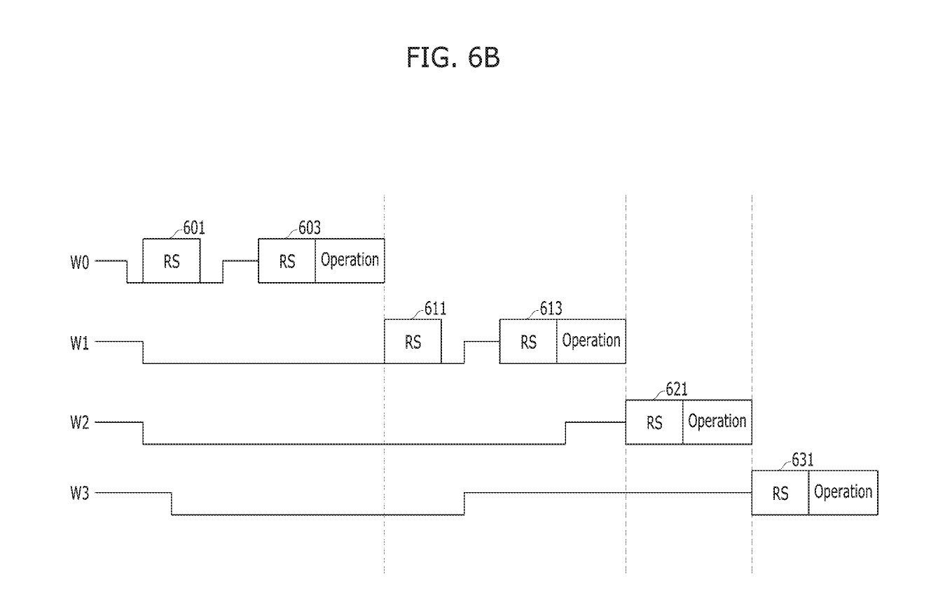

FIG. 6 shows the operation of the controller 130 according to the embodiment of the present invention. Specifically, FIG. 6 is a timing diagram showing an operation of the controller 130 to perform a status check operation based on the input order for a plurality of read commands.

As described above, the host 102 may issue a plurality of read commands to the controller 130 and store them in the buffer 510 in order.

The buffer 510 may include 0th to nth buffers. At this time, the controller 130 may store the read commands in the 0th to 3rd buffers.

The RS setting unit 530 may store the order information of the status check operations in response to the read commands, based on the order of the plurality of issued read commands.

Further, the RS performing unit 550 may control the memory device 150 to perform a status check operation for each of the ways according to the order information.

The controller 130 may receive a response from the memory device 150 regarding the status of the ways. If the status of the certain way is ‘ready’, the processor 134 may perform a corresponding input/output (I/O) operation.

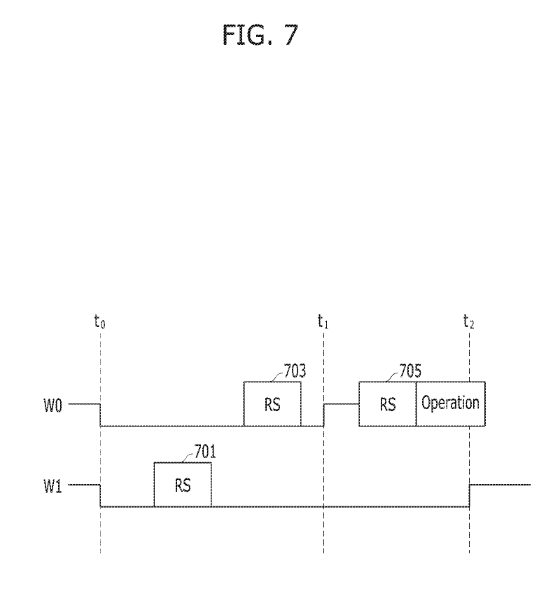

In FIGS. 6A to 7, a time line of a way shows high status when the way is ready and shows low status when the way is busy.

FIG. 6A is a timing diagram showing the operation of the controller 130 according to the embodiment of the present invention. FIG. 6A is a timing diagram showing the operation of the controller 130 when a plurality of commands are commands for random data.

Hereinafter, for convenience of description, the present invention is described using a read command, but the present invention is not limited thereto.

First, the controller 130 may control the memory device 150 to perform a status check operation on the 0th way W0 to perform the operation on the 0th read command.

According to the first status check 605, the 0th way W0 may be in the ‘busy’ status. The controller 130 may control the memory device 150 to perform a status check operation on another way. That is, the controller 130 may control the memory device 150 to perform a status check operation on the 1st way W1 after performing the status check operation on the 0th way W0.

According to the second status check 615, since the 1st way W1 is ‘busy’, the controller 130 may receive a ‘busy’ response. Then, the controller 130 may control the memory device 150 to perform a status check operation on the 2nd way W2.

According to the third status check 625, since the 2nd way W2 is ‘busy’, the controller 130 may receive a ‘busy’ response. Then, the controller 130 may control the memory device 150 to perform a status check operation on the 3rd way.

According to the fourth status check 635, since the 3rd way is ‘busy’, the controller 130 may receive a ‘busy’ response. Then, the controller 130 may control the memory device 150 to perform a status check operation on the 1st way W1 again.

According to the fifth status check 607, the 0th way W0 is in the ‘ready’ status. The controller 130 may receive a ‘ready’ response. Thus, the process 134 may control the memory device 150 to perform a read operation in response to the read command stored in the 0th buffer 510.

After the data processing in the 0th way W0 is completed, the controller 130 may control the memory device 150 to perform the sixth status check 617 on the 1st way W1. According to the sixth status check 617, since the 1st way W1 is ‘busy’, the controller 130 may receive a ‘busy’ response. Then, the controller 130 may control the memory device 150 to perform a status check operation on the 2nd way W2.

According to the seventh status check 627, the controller 130 may receive a ‘busy’ response because the 2nd way W2 is ‘busy’. Then, the controller 130 may control the memory device 150 to perform a status check operation on the 3rd way.

According to the eighth status check 637, the 3rd way is in the ‘ready’ status. The controller 130 may receive a ‘ready’ response. Thus, the process 134 may control the memory device 150 to perform a read operation in response to the command stored in the 3rd buffer 510.

After the data processing in the 3rd way is completed, the controller 130 may control the memory device 150 to perform the ninth status check 619 on the 1st way W1. According to the ninth status check 619, the 1st way W1 is in the ‘ready’ status. The controller 130 may receive a ‘ready’ response. Thus, the process 134 may control the memory device 150 to perform a read operation in response to the command stored in the 1st buffer 510.

Finally, after the data processing in the 1st way W1 is completed, the controller 130 may control the memory device 150 to perform the tenth status check 629 on the 2nd way W2. According to the ninth status check 629, the 2nd way W2 is in the ‘ready’ status. The controller 130 may receive a ‘ready’ response. Thus, the process 134 may control the memory device 150 to perform a read operation in response to the command stored in the 2nd buffer 510.

FIG. 6B is a timing diagram showing the operation of the controller 130 according to another embodiment of the present invention. Specifically, FIG. 6B is a timing diagram showing the operation of the controller 130 when a plurality of commands are commands for sequential data.

First, the RS performing unit 550 may control the memory device 150 to perform a status check operation to the 0th way W0 in order to perform a read operation in response to the 0th read command.

According to the first status check 601, the 0th way W0 may be in the ‘busy’ status. The controller 130 may receive a ‘busy’ response. However, since the 0th way W0 is the highest priority processing target, the RS performing unit 550 may not control the memory device 150 to perform a status check operation to the other way. Thus, the RS performing unit 550 may control the memory device 150 to repeat a status check operation to the 0th way W0. According to the second status check 603, since the way 0th is ‘ready’, the controller 130 may receive a ‘ready’ response. Then, the processor 134 may control the memory device 150 to perform a read operation corresponding to the command stored in the 0th buffer 510.

After the read operation is completed in the 0th way W0, the RS performing unit 550 may control the memory device 150 to perform a status check operation to the 1st way W1 in order to perform a read operation in response to the 1st read command. According to the third status check 611, the way 1st may be in the ‘busy’ status. The controller 130 may receive a ‘busy’ response. However, since the 1st way W1 is the highest priority processing target after the 0th way W0, the RS performing unit 550 may not perform a status check operation on another way (for example, the 2nd way W2 or the 3rd way). Thus, the RS performing unit 550 may control the memory device 150 to repeat a status check operation to the 1st way W1. According to the fourth status check 613, since the way 1st is ‘ready’, the controller 130 may receive a ‘ready’ response. Then, the processor 134 may control the memory device 150 to perform a read operation in response to the read command stored in the 1st buffer 510.

After the read operation is completed in the 1st way W1, the RS performing unit 550 may control the memory device 150 to perform a status check operation to the 2nd way W2 in order to perform a read operation in response to the 2nd read command. According to the fifth status check 621, since the 2nd way W2 is ‘ready’, the controller 130 may receive a ‘ready’ response. Then, the processor 134 may control the memory device 150 to perform a read operation in response to the read command stored in the 2nd buffer 510.

After the read operation is completed in the 2nd way W2, the RS performing unit 550 may control the memory device 150 to perform a status check operation to the 3rd way in order to perform a read operation in response to the 3rd read command. According to the sixth status check 631, since the way 3rd is ‘ready’, the controller 130 may receive a ‘ready’ response. Then, the processor 134 may control the memory device 150 to perform a read operation in response to the read command stored in the 3rd buffer 510.

Referring to the data processing procedure, the host 102 may sequentially issue a plurality of read commands in order, and the controller 130 may control the memory device 150 to process the data in response to the read commands in order using the status check operation based on the order information for the read commands.

FIG. 7 is a timing diagram showing the operation of the controller 130 according to another embodiment of the present invention. Hereinafter, for convenience of description, a plurality of commands are commands for random data.

The controller 130 may store information about commands transmitted from the host 102 to the memory device 150. Furthermore, the command information may include duration information of the busy statuses for the respective ways corresponding to the command.

The RS setting unit 530 may determine the duration of the busy status for each of the plurality of ways based on the command information. Further, The RS setting unit 530 may compare the durations of the busy statuses between the different ways. As described above, a plurality of commands may be sequentially stored in the buffer 510. Then, the controller 130 may issue status check commands sequentially to perform input/output operations in the memory device 150 according to the order of the commands stored in the buffer 510. In this case, the RS setting unit 530 may determine the duration of the busy status of each of the plurality of ways.

The RS performing unit 550 may control the memory device 150 to perform the status checking operation to a way to determine whether the status of the way is ‘ready’ or ‘busy’. If the status of the way is ‘busy’, the RS performing unit 550 may perform a status check operation on another way. However, if the duration of the busy status of a certain way is short, the RS setting unit 530 may change the order information to preferentially perform the status check operation to the certain way. Thus, the RS performing unit 550 may not control the memory device 150 to perform a status check operation to another way until the status check operation to the certain way of the priority is completed.

For example, according to the first status check 701 for the 1st way W1, the 1st way W1 is in a ‘busy’ status. Thereafter, a second status check 703 on the 0th way W0 may be performed.

According to the second status check 703 for the 0th way W0, the 0th way W0 is in the ‘busy’ status.

In this case, the RS setting unit 530 may determine that the ‘busy’ status of the 0th way W0 may last from time point t0 to time point t1, and the ‘busy’ status of the 1st way W1 may last from time point t0 to time point t2. That is, the RS setting unit 530 may detect that the duration of the ‘busy’ status of the 1st way W1 is longer than the duration of the ‘busy’ status of the 0th way W0 by an amount of ‘t2−t1’.

In accordance with an embodiment of the present invention, the RS setting unit 530 may change the order information so that the status check operation is prioritized for the 0th way W0, instead of the status check operation to the 1st way W1 based on the determination about the duration of the busy statuses. That is, since the duration of the busy status of the 0th way W0 is shorter than the duration of the busy status of the 1st way W1, the RS performance unit 550 may perform the third status check 705 on the 0th way W0 rather than the 1st way W1.

Further, according to the third status check 705 for the 0th way W0, since the 0th way W0 is in the ‘ready’ status, the processor 134 may control memory device 150 to perform a corresponding input/output (I/O) operation. Also, the RS performing unit 550 may perform a status check operation on the 1st way W1 after the operation is completed.

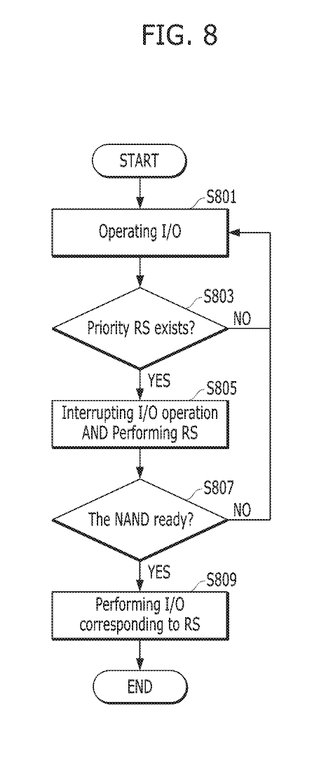

FIG. 8 is a flowchart illustrating an operation of the controller 130 according to another embodiment of the present invention.

At step S801, the controller 130 may control the memory device 150 to perform an input/output (I/O) operation corresponding to a request of the host 102. For example, the host 102 may issue a write command to the controller 130 and the controller 130 may control the memory device 150 to perform a write operation in response to the write command. That is, the write operation may be performed in the memory device 150.

At step S803, during the input/output (I/O) operation described in step 801, there may be input/output (I/O) operation to be performed prior to the input/output (I/O) operation being currently performed for efficient data processing of the memory system 110.

For example, since the time required for the write operation is relatively longer than the read operation, it may be necessary to readjust the order to preferentially perform the read operation during the write operation. Therefore, the RS setting unit 530 may store the order information so that the RS may have priority over the status check operation corresponding to the read operation, rather than the write operation.

If there is no input/output (I/O) operation to be performed prior to the input/output (I/O) operation being currently performed (NO in step S803), the controller 130 may continue performing the input/output (I/O) operation being performed.

Whereas, if there is an input/output (I/O) operation to be performed prior to the input/output (I/O) operation being currently performed (Yes in step S803), the RS performing unit 550 may interrupt at step S805 the currently performed input/output (I/O) operation temporarily and perform a status check operation corresponding to the input/output (I/O) operation to be performed prior to the input/output (I/O) operation being currently performed. For example, the RS performing unit 550 may interrupt a currently performed write operation temporarily and perform a status check operation corresponding to a read operation, which is to be performed prior to the currently performed write operation.

At step S807, the RS performing unit 550 may control the memory device 150 to perform a status check operation on the way corresponding to the input/output (I/O) operation to be performed with the priority.

If the status of the way is not ‘ready’ (NO in step S807), the processor 134 may control the memory device 150 to continue performing the temporarily interrupted input/output (I/O) operation.

Whereas, if the status of the way is ‘ready’ (Yes in step S807), after completing the status check operation, the processor 134 at step S809 may control the memory device 150 to perform the corresponding input/output (I/O) operation to be performed with the priority. Although not shown in the figure, after the input/output (I/O) operation performed in step S809 is completed, the processor 134 may perform the memory device 150 to perform the temporarily interrupted input/output (I/O) operation.

Thus, the RS performing unit 550 may perform the status check operation during the write or read operation.

As described above, the firmware only serves to transfer the command set from the host 102 to the memory device 150, and the controller 130, i.e., hardware, may control the status check operation. Thus, the controller 130 may control the memory device 150 to perform a status check operation in accordance with the command set. That is, the performance of the memory system 110 may be improved by performing the status check operation according to the stored order information, not depending only on the input/output (I/O) status of the memory device 150.

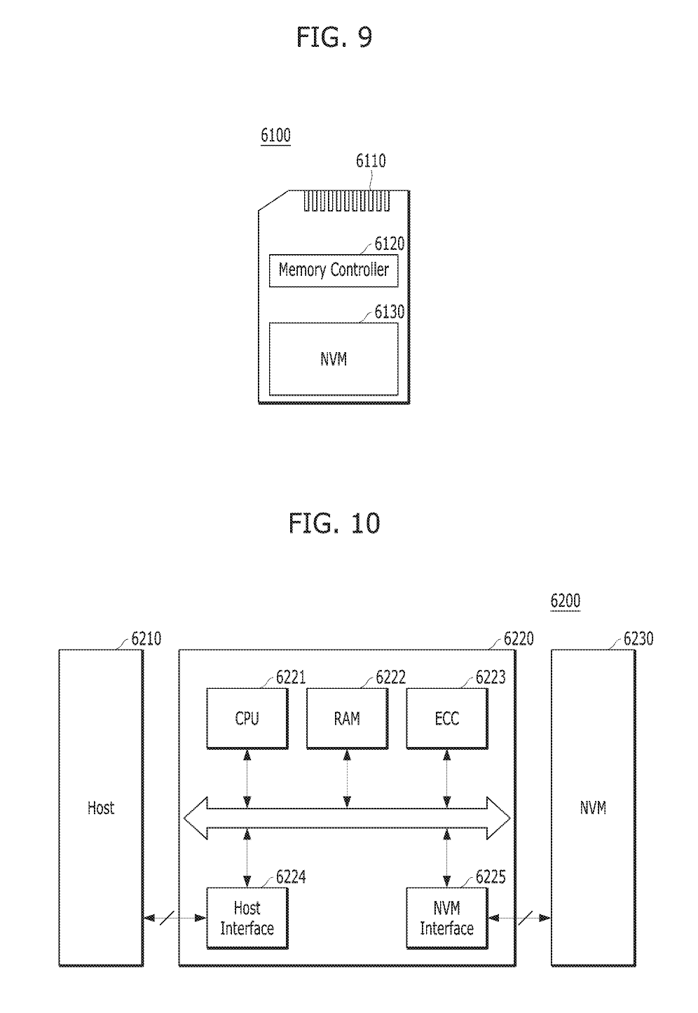

Hereinafter, FIGS. 9 to 17 are diagrams schematically illustrating application examples of the data processing system of FIGS. 1 to 8 according to various embodiments.

FIG. 9 is a diagram schematically illustrating another example of the data processing system including the memory system in accordance with the present embodiment. FIG. 9 schematically illustrates a memory card system to which the memory system in accordance with the present embodiment is applied.

Referring to FIG. 9, the memory card system 6100 may include a memory controller 6120, a memory device 6130 and a connector 6110.

More specifically, the memory controller 6120 may be connected to the memory device 6130 embodied by a nonvolatile memory, and configured to access the memory device 6130. For example, the memory controller 6120 may be configured to control read, write, erase and background operations of the memory device 6130. The memory controller 6120 may be configured to provide an interface between the memory device 6130 and a host, and drive firmware for controlling the memory device 6130. That is, the memory controller 6120 may correspond to the controller 130 of the memory system 110 described with reference to FIGS. 1 to 8, and the memory device 6130 may correspond to the memory device 150 of the memory system 110 described with reference to FIGS. 1 to 8.

Thus, the memory controller 6120 may include a RAM, a processing unit, a host interface, a memory interface and an error correction unit. The memory controller 130 may further include the elements described in FIG. 1.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with the present embodiment may be applied to wired/wireless electronic devices or particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM). The memory device 6130 may include a plurality of dies as in the memory device 150 of FIG. 1.

The memory controller 6120 and the memory device 6130 may be integrated into a single semiconductor device. For example, the memory controller 6120 and the memory device 6130 may construct a solid state driver (SSD) by being integrated into a single semiconductor device. Also, the memory controller 6120 and the memory device 6130 may construct a memory card such as a PC card (PCMCIA: Personal Computer Memory Card International Association), a compact flash (CF) card, a smart media card (e.g., SM and SMC), a memory stick, a multimedia card (e.g., MMC, RS-MMC, MMCmicro and eMMC), an SD card (e.g., SD, miniSD, microSD and SDHC) and a universal flash storage (UFS).

FIG. 10 is a diagram schematically illustrating another example of the data processing system including a memory system, in accordance with the present embodiment.

Referring to FIG. 10, the data processing system 6200 may include a memory device 6230 having one or more nonvolatile memories and a memory controller 6220 for controlling the memory device 6230. The data processing system 6200 illustrated in FIG. 10 may serve as a storage medium such as a memory card (CF, SD, micro-SD or the like) or USB device, as described with reference to FIG. 1. The memory device 6230 may correspond to the memory device 150 in the memory system 110 described in FIGS. 1 to 8, and the memory controller 6220 may correspond to the controller 130 in the memory system 110 described in FIGS. 1 to 8.

The memory controller 6220 may control a read, write or erase operation on the memory device 6230 in response to a request of the host 6210, and the memory controller 6220 may include one or more CPUs 6221, a buffer memory such as RAM 6222, an ECC unit 6223, a host interface 6224 and a memory interface such as an NVM interface 6225.

The CPU 6221 may control the operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC unit 6223 may correspond to the ECC unit 138 illustrated in FIG. 1. As described with reference to FIG. 1, the ECC unit 6223 may generate an ECC (Error Correction Code) for correcting a fail bit or error bit of data provided from the memory device 6230. The ECC unit 6223 may perform error correction encoding on data provided to the memory device 6230, thereby forming data with a parity bit. The parity bit may be stored in the memory device 6230. The ECC unit 6223 may perform error correction decoding on data outputted from the memory device 6230. At this time, the ECC unit 6223 may correct an error using the parity bit. For example, as described with reference to FIG. 1, the ECC unit 6223 may correct an error using the LDPC code, BCH code, turbo code, Reed-Solomon code, convolution code, RSC or coded modulation such as TCM or BCM.

The memory controller 6220 may transmit/receive data to/from the host 6210 through the host interface 6224, and transmit/receive data to/from the memory device 6230 through the NVM interface 6225. The host interface 6224 may be connected to the host 6210 through a PATA bus, SATA bus, SCSI, USB, PCIe or NAND interface. The memory controller 6220 may have a wireless communication function with a mobile communication protocol such as WiFi or Long Term Evolution (LTE). The memory controller 6220 may be connected to an external device, for example, the host 6210 or another external device, and then transmit/receive data to/from the external device. In particular, as the memory controller 6220 is configured to communicate with the external device through one or more of various communication protocols, the memory system and the data processing system in accordance with the present embodiment may be applied to wired/wireless electronic devices or particularly a mobile electronic device.

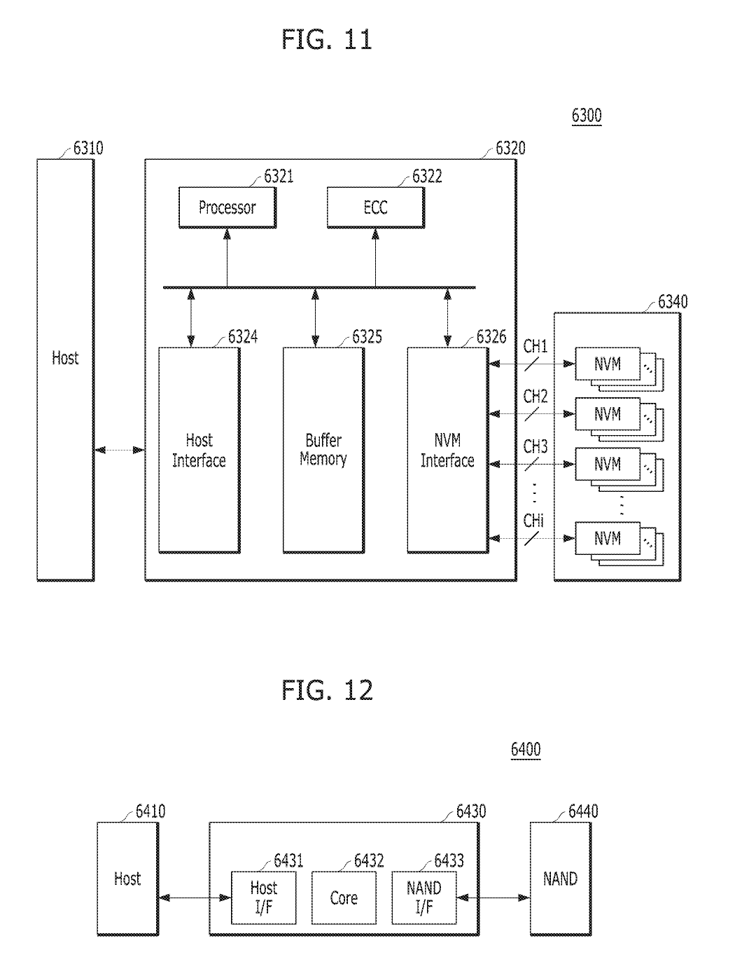

FIG. 11 is a diagram schematically illustrating another example of the data processing system including the memory system in accordance with the present embodiment. FIG. 11 schematically illustrates an SSD to which the memory system in accordance with the present embodiment is applied.

Referring to FIG. 11, the SSD 6300 may include a controller 6320 and a memory device 6340 including a plurality of nonvolatile memories. The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, a buffer memory 6325, an ECC unit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340, or temporarily store meta-data of the plurality of flash memories NVM, for example, map data including a mapping table. The buffer memory 6325 may be embodied by volatile memories such as DRAM, SDRAM, DDR SDRAM, LPDDR SDRAM and GRAM or nonvolatile memories such as FRAM, ReRAM, STT-MRAM and PRAM. For convenience of description, FIG. 11 illustrates that the buffer memory 6325 exists in the controller 6320. However, the buffer memory 6325 may exist outside the controller 6320.

The ECC unit 6322 may calculate an ECC value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, RAID (Redundant Array of Independent Disks) system. At this time, the RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 12 is a diagram schematically illustrating another example of the data processing system including the memory system in accordance with an embodiment. FIG. 12 schematically illustrates an embedded Multi-Media Card (eMMC) to which the memory system in accordance with an embodiment is applied.

Referring to FIG. 12, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control the operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, UHS ((Ultra High Speed)-I/UHS-II) interface.

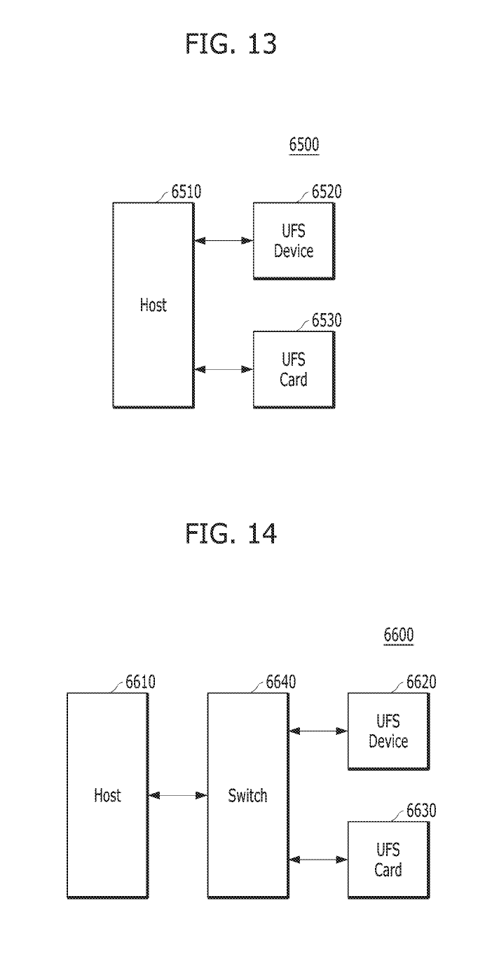

FIGS. 13 to 16 are diagrams schematically illustrating other examples of the data processing system including the memory system in accordance with an embodiment. FIGS. 13 to 16 schematically illustrate UFS (Universal Flash Storage) systems to which the memory system in accordance with an embodiment is applied.

Referring to FIGS. 13 to 16, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired/wireless electronic devices or particularly mobile electronic devices, the UFS devices 6520, 6620, 6720 and 6820 may serve as embedded UFS devices, and the UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired/wireless electronic devices or particularly mobile electronic devices through UFS protocols, and the UFS devices 6520, 6620, 6720 and 6820 and the UFS cards 6530, 6630, 6730 and 6830 may be embodied by the memory system 110 illustrated in FIG. 1. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 9 to 11, and the UFS cards 6530, 6630, 6730 and 6830 may be embodied in the form of the memory card system 6100 described with reference to FIG. 9.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720 and 6820 and the UFS cards 6530, 6630, 6730 and 6830 may communicate with each other through various protocols other than the UFS protocol, for example, UFDs, MMC, SD, mini-SD, and micro-SD.

In the UFS system 6500 illustrated in FIG. 13, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. At this time, the UFS device 6520 and the UFS card 6530 may communicate with each other through link layer switching at the UniPro of the host 6510. In the present embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410, and a plurality of UFS cards may be connected in parallel or in the form of a star to the UFS device 6520 or connected in series or in the form of a chain to the UFS device 6520.

In the UFS system 6600 illustrated in FIG. 14, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the present embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

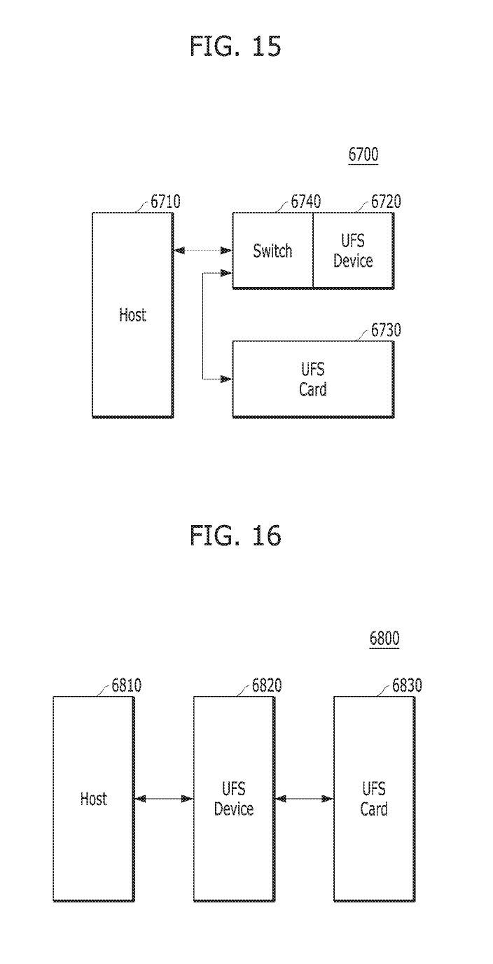

In the UFS system 6700 illustrated in FIG. 15, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. At this time, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In the present embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 16, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. At this time, the host 6810 and the UFS card 6830 may communicate with each other through target ID switching between the M-PHY and UniPro modules of the UFS device 6820. In the present embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

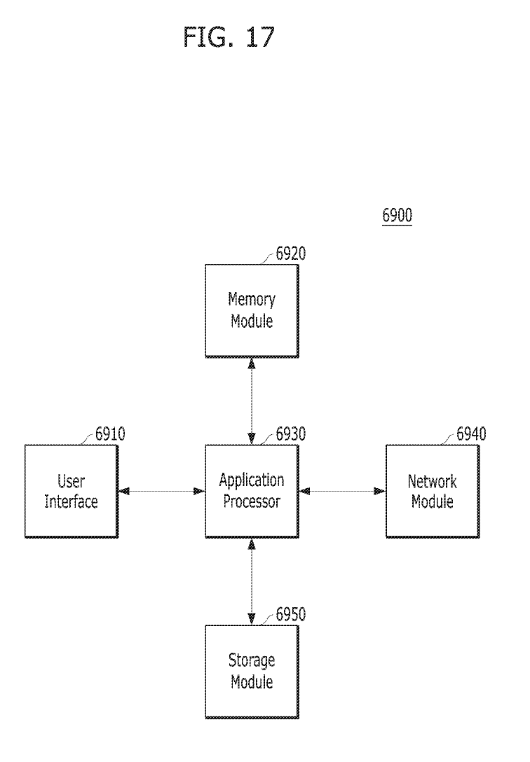

FIG. 17 is a diagram schematically illustrating another example of the data processing system including the memory system in accordance with an embodiment. FIG. 17 is a diagram schematically illustrating a user system to which the memory system in accordance with an embodiment is applied.

Referring to FIG. 17, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as a System-on-Chip (SoC).

The memory module 6920 may be used as a main memory, work memory, buffer memory or cache memory of the user system 6900. The memory module 6920 may include a volatile RAM such as DRAM, SDRAM, DDR SDRAM, DDR2 SDRAM, DDR3 SDRAM, LPDDR SDARM, LPDDR3 SDRAM or LPDDR3 SDRAM or a nonvolatile RAM such as PRAM, ReRAM, MRAM or FRAM. For example, the application processor 6930 and the memory module 6920 may be packaged and mounted, based on POP (Package on Package).

The network module 6940 may communicate with external devices. For example, the network module 6940 may not only support wired communication, but may also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 9 to 16.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control the operations of the mobile electronic device, and the network module 6940 may serve as a communication module for controlling wired/wireless communication with an external device. The user interface 6910 may display data processed by the processor 6930 on a display/touch module of the mobile electronic device, or support a function of receiving data from the touch panel.

While the present invention has been described with respect to specific embodiments, it will be apparent to those skilled in the art that various changes and modifications may be made without departing from the spirit and scope of the invention as defined in the following claims.

What is claimed is:

1. A controller comprising:
a buffer for storing a plurality of commands in accordance with an input order;
a setting unit for setting order information of a read status check operation to be performed on respective storage devices corresponding to the plurality of commands, wherein the storage devices are included in a memory device;
a performing unit for controlling the memory device to sequentially perform the read status check operation based on the order information; and
a processor for controlling the memory device to perform a command operation in response to the plurality of commands based on a result of the read status check operation.

2. The controller of claim 1, wherein the buffer has a ring buffer structure.

3. The controller of claim 1,
wherein the setting unit sets, when the plurality of commands are commands for sequential data, the order information to be the same as the order of input commands for the sequential data, and
wherein the performing unit controls the storage devices to repeatedly perform the status check for each storage device until a command operation performed in each of the storage devices is completed.

4. The controller of claim 3, wherein the performing unit controls the memory device to perform a read status check operation corresponding to a subsequent command, after the command operation for a preceding command is completed according to the order information.

5. The controller of claim 1,
wherein the setting unit sets, when the plurality of commands are commands for random data, the order information to be the same as the order of input commands for the random data, and
wherein the performing unit controls the memory device to alternately perform the read status check operation on the storage devices until the command operation on the storage devices is completed.

6. The controller of claim 5,
wherein the setting unit changes, when one or more storage devices is determined as busy according to a result of performing the read status check operation on each of the storage devices, the order information based on the command information, and
wherein the command information includes predetermined duration information of a busy status for a storage device corresponding to a corresponding command.

7. The controller of claim 6,
wherein the setting unit compares the duration information corresponding to the preceding command with the duration information corresponding to the subsequent command based on the command information and changes the order information so as to preferentially control the memory device to perform the read status check operation to the subsequent command having the shorter time, and
wherein the performing unit controls the memory device to sequentially perform the read status check operation based on the changed order information.

8. The controller of claim 1,
wherein the setting unit changes, when a subsequent command is a read command and is issued while a write operation is being performed in response to a preceding write command, the order information to perform the read status check operation on the storage device corresponding to the read command first, and
wherein the performing unit controls the memory device to interrupt the write operation and perform the read status check operation corresponding to the read command, and
wherein the processor controls the memory device to perform a read operation corresponding to the read command based on the status of a corresponding storage device.

9. The controller of claim 8, wherein, after the read operation is completed, the processor controls the memory device to resume the interrupted write operation.

10. The controller of claim 1, wherein the storage device includes a way of a memory device.

11. An operating method for a controller comprising:
a first step of storing a plurality of commands in a buffer according to an input order of the commands;
a second step of storing order information of a read status check operation to be performed for each of a plurality of storage devices of a memory device corresponding to each of the plurality of commands;
a third step of controlling the memory device to sequentially perform the read status check operation to the storage devices based on the order information; and
a fourth step of controlling the memory device to perform command operations in response to the plurality of commands based on a result of the read status check operation.

12. The operating method of claim 11, herein the buffer has a ring buffer structure.

13. The operating method of claim 11,
wherein the second step stores, when the plurality of commands are commands for sequential data, the order information in the same order as the order of input commands for the sequential data, and
wherein the third step controls the storage devices to repeatedly perform the read status check operation for each storage device until a command operation performed in each of the storage devices is completed.

14. The operating method of claim 13, wherein the third step controls the memory device to perform the status check operation on a subsequent command after the command operation for a preceding command is completed according to the order information.

15. The operating method of claim 11,
wherein the second step sets, when the plurality of commands are commands for random data, the order information to be the same as the order of input commands for the random data, and
wherein the third step controls the memory device to alternately perform the read status check operation on the storage devices until the command operation on the storage devices is completed.

16. The operating method of claim 15,
further comprising a fifth step of changing, when one or more storage devices determined as busy according to a result of the performing of the read status check operation on each of the storage devices, the order information based on the command information,
wherein the command information includes predetermined duration information of a busy status for a storage device corresponding to a corresponding command.

17. The operating method of claim 16,
wherein the fifth step compares the duration information corresponding to the preceding command with the duration information corresponding to the subsequent command based on the command information and changes the order information so as to preferentially control the memory device to perform the read status check operation to the subsequent command having the shorter time, and
further comprising, a sixth step of controlling the memory device to sequentially perform the read status check operation based on the changed order information.

18. The operating method of claim 11,
wherein the second step changes, when a subsequent command is a read command and is issued while a write operation is being performed in response to a preceding write command, the order information to perform the read status check operation on the storage device corresponding to the read command first, and
wherein the third step controls the memory device to interrupt the write operation and perform the read status check operation corresponding to the read command, and
wherein the fourth step controls the memory device to perform a read operation corresponding to the read command based on the status of a corresponding storage device.

19. The operating method of claim 18, further comprising a fifth step of controlling, after the read operation is completed, the memory device to resume the interrupted write operation again.

20. The operating method of claim 11, wherein the storage device includes a way of a memory device.

21. A memory system comprising:
a memory device including a plurality of storage devices; and
a controller suitable for:
performing, in response to an ordered sequence of commands, an ordered sequence of status check operations to the storage devices respectively corresponding to the ordered sequence of commands; and
performing a plurality of command operations respectively corresponding to the commands according to results of the status check operations,
wherein the performing of the ordered sequence of status check operations includes repeating the status check operation corresponding to a next command until completion of a current command operation.
